(19) United States
(12) Patent Application Publication
(10) Pub. No.: US 2014/0127270 A1
(43) Pub. Date: May 8, 2014

(54) Compositions and Methods for Preventing and Ameliorating Fouling on Medical Surfaces

(71) Applicant: Tina Amarnani, Menlo Park, CA (US)

(72) Inventor: Tina Amarnani, Menlo Park, CA (US)

(21) Appl. No.: 13/836,067

(22) Filed: Mar. 15, 2013

Related U.S. Application Data
(60) Provisional application No. 61/723,159, filed on Nov. 6, 2012.

(51) Int. Cl. C09D 5/16

(52) U.S. Cl. CPC C09D 5/1662
USPC 424/400; 424/78.37; 424/78.35

(57) ABSTRACT

A composition which can be detached from a surface which composition serves the purpose of impeding the detrimental effects of adherent fouling from the environment surrounding the surface. The composition may be single layered or multilayered as to allow for removal or attachment at multiple time points and/or over different durations. These time points may correspond to a progression to a negative effect of fouling, such as progression from biofilm maturation to bacterial detachment into host tissue for indwelling medical devices, or a predetermined threshold of tolerable fouling effect, such as blockage of a foley catheter by organic and inorganic encrustation material. This composition does not contribute to the function of the surface or the object whose boundaries are defined by the surface, such that its attachment or detachment is primarily aimed at mitigating the effects of fouling.

### FIELD OF THE INVENTION

The present invention generally relates to articles which can prevent the accumulation of unwanted material on a surface.

### BACKGROUND

Biological material, including protein, inorganic molecules, viruses, bacteria, and fungi, can adhere to and accumulate on any surface. The adherence of microbes, particularly bacteria and fungi, to medical surfaces is particularly problematic because of the ability of those adherent microbes to form biofilm.

Biofilms are an aggregate of microbes embedded in an extracellular polymeric matrix on a surface. The microbes in a biofilm are highly resistant to traditional drug therapies as compared to their free-floating counterparts, making biofilm very difficult to eliminate when it forms on surfaces contained within the body. Furthermore, mature biofilm can act as a continuous delivery source of microbes to patient tissue, and can thereby cause persistent infection in the patient until the biofilm is removed. The microbes dispersed from biofilm can be transmitted to patient tissue through inhalation of aerosolized microbes, direct dispersal into host tissue, or indirect contact transmission through an intermediary object or person. Although any surface exposed to a non-sterile environment is susceptible to biofilm, its formation on medical devices is an especially severe problem. Indwelling medical devices which extend partially inside the body (e.g. foley catheters) or implanted devices which operate completely inside the body (e.g. pacemakers) can cause persistent clinical infection if biofilm develops on their surface. Once a patient presents with a clinical infection from a biofilm covered device, the only effective treatment is to remove the device to eliminate the continuous source of microbes and administer appropriate medications to eliminate the drug-sensitive, free-floating microbes that have been released from the biofilm. Removal of the device can be problematic because its functionality is required for patient care. After removal, devices cannot be replaced in the patient until the microbes released into the patient have been eliminated by medication or host immune functions, which can take up to four to six weeks. Preventative measures to avoid contamination of the device through material modifications such as antimicrobial or antiseptic agents coated on the device have demonstrated mixed results at best.

Similarly, any medical equipment (e.g., stethoscopes, blood pressure cuffs) or medical facility surfaces (e.g., tabletops, air vents) are susceptible to biofilm formation, and they can act as sources of microbe transmission to patient tissue. Biofilm can be eliminated with detergents and mechanical scrubbing when it forms on surfaces outside of the body, but in practice, frequent manual cleaning of large areas of biofilm susceptible surfaces is costly and time-intensive.

Accordingly, it is an object of the invention to provide alternative ways to mitigate biofilm and its formation, especially in the medical setting. Similarly, it is an object of the invention to mitigate detrimental effects caused by biofilm, such as catheter thrombosis and encrustation, associated with unwanted accumulation of non-microbe biological material.

### SUMMARY OF THE INVENTION

The present invention generally relates to the mitigation of adverse effects associated with the formation of a biofilm and/or accumulation of other unwanted organic and inorganic material on medical surfaces. More specifically, the invention relates to compositions and methods that prevent or inhibit adhesion of microbes, and subsequent biofilm formation. The invention also relates to composition and methods that prevent or inhibit the dispersal of microbes from a biofilm into the surrounding environment. Additionally, the invention relates to composition and methods to prevent or inhibit the adhesion of certain proteins that can lead to thrombus formation on surfaces and crystallized inorganic material that can lead to encrustation. In an embodiment, the goals of the invention are achieved by removing a portion or the entirety of a composition of the invention from the object surface. Compositions and articles of the invention include a composition made of polymers configured to cover at least a portion of the object surface, thereby preventing the adhesion of unwanted material directly on the object surface. The object surface is defined as the physical boundaries of the object in the absence of the compositions of the invention, wherein the object has form and function completely independent from the compositions of the invention. As contemplated by the invention, unwanted material adheres to the surface of the composition rather than attaching directly to the object surface. In the absence of the compositions of the invention in equivalent environmental conditions, the unwanted material could adhere to the object surface. The composition is configured to be removed from the object surface in a manner that prevents contamination of the underlying object surface. In addition, the compositions of the invention do not interfere with the operation, form or function of the underlying object. These compositions can be single or multi-layered. In the multi-layered embodiment, individual layers may erode, dissolve, dissolute, disintegrate, degrade, or be removed at different times and at different rates.

The compositions of the invention have numerous benefits, especially in the medical context. A primary benefit is the prevention of clinical infection that may occur when microbes from a contaminated medical device disperse into the patient. Clinical infection is defined by local signs, such as redness, swelling, or pain around the insertion site, or systemic signs such as fever, hemodynamic instability, bacteremia, fungemia, and elevated white blood cell count. Composition and methods of the invention may eliminate the need to remove medical devices from the host when it is believed that a biofilm has formed on the device, either prior to or following signs and symptoms of clinical infection. The composition may be able to prevent clinical complications secondary to the accumulation of non-microbe material, including without limitation, proteins implicated in the thrombosis of vascular catheters and grafts and crystallized inorganic material implicated in the encrustation of urinary catheters. In addition, compositions and methods of the invention eliminate the need for harsh sterilizing procedures that may potentially damage the device, including the use of autoclaving or treatment of the device with harmful chemicals. The compositions of the invention can also protect the underlying device from biofilm-associated damage and increase the lifespan of the device.

The compositions of the invention may be removed from the associated device by any means or combination of means known in the art useful for removing, dissolving, degrading, eroding, or inducing conformational changes of the constituents of the composition from the associated device. The composition can be removed through, for example, physical or mechanical means, chemical means, enzymatic means, or energetic means. The composition can also be removed by temporally-fixed degradation or stimulated degradation. In temporally-fixed degradation, as seen in traditional biodegradable polymers, the material used to prepare the composition layer degrades at a pre-characterized rate under given environmental conditions. In stimulated degradation, as seen in smart polymers, a change in the environment is used to trigger the removal of the composition. For example, the composition may be prepared from a polymer configured to degrade, dissolve, or change from a linear polymer to a micellized polymer in response to changes in the environment. Such changes can include, without limitation, changes in pH, temperature, light, electrical fields, magnetic fields, ionic factors, and interacting molecules. Furthermore, if the composition includes multiple layers, each layer may be configured to degrade, dissolve, erode, etc. by different means and/or at different times. This may allow for timed release of microbes or unwanted material adhered to the surface of the composition at different times.

Compositions of the invention can be used with any object or device. In an embodiment, the compositions are especially adapted for use with medical devices susceptible to biofilm formation. Medical devices include, without limitation, urological devices, intravascular devices, orthopedic devices, neurological devices, pulmonary devices, thoracic devices, gynecological devices, Ear Nose Throat (ENT) devices, ophthalmology devices, cosmetic implants, gastroenterological devices, dental implants, and treatment release implants. Additionally, compositions of the invention can be readily applied to medical equipment, which may include, without limitation, stethoscopes, sphygmomanometers, otoscopes, opthalmoscopes, bronchoscopes, endoscopes, colonoscopes, hysteroscopes, colposcopes, culdoscope, suction tubes, specula, and HVAC systems. Certain compositions of the invention may also be applied to other surfaces in clinical care or long term care facilities that are susceptible to biofilm formation, including without limitation, walls, tabletops, ventilation ducts, water piping, bed surfaces, door handles, and support railings. In an embodiment of the invention, the composition is a removable faux surface that overlies the entirety of the device surface lying within and/or contacting patient tissue. In an embodiment, the composition is mechanically removed. In another embodiment, the composition is a decomposable, erodible, dissolvable or the like. A mechanically removed composition may be removed from the device during or following insertion.

In an embodiment, the composition is removed prior to the microbe dispersal stage of the biofilm lifecycle. For example, a decomposable composition on an indwelling or implanted medical device begins decomposing, eroding, dissolving or the like in vivo soon after insertion. In an embodiment, a decomposable composition on an indwelling or implanted medical device begins decomposing, eroding, dissolving, dissoluting, degrading or the like in vivo soon after insertion and continues to decompose for a period of time. In an embodiment, the compositions of the invention decompose, erode, dissolve, dissolute, degrade, or otherwise are removed for the entire lifespan of the device in vivo. In an alternative embodiment, the decomposition, erosion, dissolution, degradation or the like initiates prior to the exponential growth phase of adherent microbes, such that the number of microbes released into the host tissue is minimized. In an embodiment of the invention, the decomposition, erosion, dissolution, or degradation of the composition occurs prior to the microbe load on the composition surface surpassing the minimally infective dose for adherent microbes, such that their release into host tissue will not cause clinical infection. In another embodiment, decomposition, erosion, degradation, dissolution, or the like can begin at a later time point to mitigate a later microbe adhesion event. In another embodiment, decomposition, erosion, degradation, dissolution, or the like can begin later in the biofilm lifecycle. In such embodiments, removal of the composition may be coupled with the administration of antibiotics, antifungals, antiseptics, or the like. In this embodiment, the administered antibiotic or antifungal will clear the free-floating microbes from host tissue more effectively than if the microbes are located in the biofilm.

### BRIEF DESCRIPTION OF THE DRAWINGS

FIG. 1 depicts a composition of the invention in conjunction with an indwelling urinary catheter, also known as a foley catheter, from a side perspective with the single layer composition.

FIG. 2 depicts an embodiment of tag configuration from a cross section perspective of an embodiment of the composition that utilizes a mechanical peel-away method of removal facilitated by tags or tabs, as described in Example 2.

FIG. 3 depicts a tag configuration from a cross section perspective of an embodiment of the composition that utilizes a mechanical peel-away method of removal facilitated by tags or tabs.

FIGS. 4A-4C depict the mechanical peel-away process of removing a single layer composition from a catheter.

FIG. 4B depicts the initial eversion of the layer of the composition when retraction force is applied on the tags at the proximal end and translated to the connection points at the distal end. 4B.A refers to these connection points between the tags and the layer at the distal end of the catheter. 4B.B refers to the net force vector applied as retraction force on the tags and translated to the connection point between the tags and layer at the distal end of the catheter. FIG. 4C depicts the layer of the composition partially peeled away from the underlying catheter surface. 4C.A refers to the underlying catheter surface after the layer of the composition has been peeled away from that portion of the catheter. 4C.B refers to the sterile underside of the layer of the composition that interfaced with the catheter surface before being peeled away. 4C.0 refers to the contaminated top side of the layer of the composition that was exposed to unwanted material in the environment. 4C.D refers to the connection points between the tags and the layer of the composition at the distal end of the catheter.

FIG. 5 is a schematic of a bilayer composition of the invention in conjunction with the pulse generator of a cardiac implantable electronic device.

FIG. 6 is a schematic of a bilayer composition of the invention in a conjunction with a CIED lead.

### DETAILED DESCRIPTION

Degradation, erosion, decomposition, solvation, and dissolution are used interchangeably with respect to polymers and compositions and refer to a change in the structural or physical properties such that there is a steady removal of the constituent material under given environmental conditions. Polymers or coatings that are degraded under physiologic conditions are additionally referred to as biodegradable, bioabsorpable, and bioresorpable. Such changes can include without limitation hydrolytic cleavage, metabolic processes, oxidation, enzymatic cleavage, phase changes, changes in miscibility, changes in intermolecular interactions, and any combination of the aforementioned.

Physiologic conditions are used to describe the temperature, pH, and ionic state within human tissue. For example, normal core body temperature is 37 degrees Celsius, normal pH of human blood and many other human tissues is about 7.4.

The object surface is defined as the physical boundaries of the object in the absence of the compositions of the invention, wherein the object has form and function completely independent from the compositions of the invention.

The invention generally relates to compositions and methods that mitigate the detrimental effects of unwanted material on object surfaces by removing it from the object surface. The invention can involve a medical device with compositions of the invention, and methods of using such a device with the compositions of the invention. In this embodiment, the medical device is configured for at least partial insertion inside the body and the composition can, for example, mitigate the clinical infection effects of microbe adhesion on medical device surfaces. In this embodiment, the composition of the invention is configured to cover at least a portion of the medical device. In certain aspects, the invention can also involve the composition alone, and methods of using the compositions of the invention.

Medical device associated infection can arise when biofilm forms on the surface of the device. The mechanism of biofilm growth on any surface and link to clinical infection can be described, for example, as follows: (1) Conditioning Film: Adherence and Adsorption of protein, polysaccharide, ions, and fluid; (2) Microbe Adhesion: microbes are seeded onto a surface via direct contact or migration from a distal site and irreversibly attaches; (3) Adherent Microbe Proliferation; (4) Extracellular Matrix Deposition; (5) Microbe Dispersal from Mature Biofilm; (6) Transmission of Microbe to Host Tissue, via contact, airborne, or droplet transmission; (7) Proliferation of Microbe within Host Tissue Locally; (8) Potential Systemic Spread of Microbe through Lymphatic and Bloodstream Penetration.

Microbe seeding refers to the initial reversible adhesion onto a surface. If 100% of seeded microbes are removed from the device surface prior to the formation of biofilm, device associated infection can be greatly reduced and most cases prevented. If any microbes remain on the device surface, biofilm can form on that surface and lead to continuous microbe dispersal into host tissue causing clinical infection. If microbes are dispersed from the device surface during the lag phase prior to entry into exponential growth, the microbe load released into the surrounding tissue can be small to moderate (<10⁵ CFU). If this microbe load is lower than the minimally infective dose of the microbe, the patient's host immune system should clear the microbe without clinical signs of infection. If the surface microbe load released into host tissue is greater than the minimally infective dose for the microbe, as it could be following entry of adherent microbes into the exponential growth phase in both induced release and natural dispersal, the patient may present with a clinical infection and require antibiotics or antifungals to clear the planktonic, drug-susceptible microbes in the host tissue. In some patients clinical infection remains persistent until the continuous source of microbes into host tissue, biofilm in the dispersal lifecycle stage, is eliminated.

The time prior to microbial detachment is the aggregate of the time to complete steps 1-4 above. Exemplary estimates of the time to complete each step are presented below. The time to complete step 1, conditioning film deposition, can be assumed to be negligible given the abundance of organic and inorganic compounds in any natural biological environment. This step was demonstrated to occur within the first minutes of implantation of ureteral stents into the urinary tract. The time to complete step 2, microbe adherence and migration to the in vivo portion of the device, is dependent upon the mechanism of microbial seeding, type of microbe, and surface material properties. For example, the adherence and migration time is negligible when the seeding occurs during insertion of an indwelling or implanted medical device. The overwhelming majority, about 90-93%, of device associated infections are caused by seeding during insertion, generally from skin flora at the insertion site. Migration times are most pertinent in the discussion of migratory microbe seeding following insertion in indwelling devices, and are pertinent to seeding of urinary catheters by Psuedomonas and E. coli. Microbes can migrate along an indwelling urinary catheter, i.e. foley catheter, surface from a contaminated urine bag, tubing, or periurethral skin to the portion of the catheter lying within the patient's urethral tract. Migration can take an estimated 2-6 days on the extraluminal surface and 16-24 hours on the intraluminal surface following contamination of the attached tubing or urine bag.

The time required to complete steps 3 and 4, microbe proliferation and biofilm maturation, is variable and based upon a number of factors, including material properties, microbe characteristics, flow conditions, and nutrient availability. Microbe proliferation rates during early biofilm formation are highly dependent upon the virulence of the microbe. Most biofilm microbes demonstrate logarithmic growth, and the lag phase duration (on the device surface) prior to the exponential growth stage is dependent, in part, upon the virulence of the microbe. S. aureus is considered the most virulent of the microbes commonly found in device associated infection, and has demonstrated a lag phase in vitro of less than 4 hours under physiological conditions. The vast majority of indwelling and implanted devices are at risk for S. aureus seeding from skin insertion sites. A number of clinical studies suggest that the process of microbe proliferation and subsequent biofilm maturation can occur within 24 hours for common microbes associated with foley catheters. Therefore, with regards to foley catheters, biofilm has the opportunity to progress to bacteremia and/or catheter associated urinary infection at approximately 24 hours if seeding occurs at insertion and every 72 hours subsequently when microbes migrate into the indwelling portion of the foley.

### Surface Application Types: Devices, Equipment, Other

As previously mentioned, the invention can involve a medical device with compositions of the invention, and methods of using such a device with the compositions of the invention. Compositions of the invention are especially useful in conjunction with indwelling and implanted medical devices. An indwelling device is inserted into the body through natural or man-made orifices and for an extended period of time, have a portion of the device residing inside the body and a portion of the device residing outside the body. An implanted medical device lies entirely inside the body during operation, and does not have any portion of the device extending outside the body. Such indwelling and implanted medical devices include without limitation urological devices (e.g., penile implants, testicular implants, pessaries, uretal stents, foley catheters, suprapubic catheters, etc. and all connected components, such as connectors, urine bags); intravascular devices (e.g., intracardiac devices, ventricular assist devices, vascular grafts, mechanical and bioprosthetic valves, vessel stents, central venous catheters, peritoneal catheters, peripheral intravenous catheters, arterial catheters, ports, and all connected extravascular components, such as connector tubing, catheter hubs, and subcutaneous intracardiac device generators); orthopedic devices (e.g., screws, pins, plates, rods, and other fracture fixation devices, joint prosthetics, and artificial disks); neurological devices (e.g. ventricular shunts and neurological stimulators); pulmonary devices (e.g., endotracheal tubes, tracheostomy tubes, airway masks, other prosthetic airways and associated ventilator and tubing equipment); thoracic devices (e.g., chest tubes); gynecological devices (e.g., intrauterine devices and vaginal stents); ENT devices (e.g., tympanostomy tubes, cochlear implants); ophthalmology devices (e.g., intra ocular lenses, glaucoma implants, and extra-ocular contact lenses); cosmetic implants (e.g., breast implants); gastroenterological devices (e.g., gastric bands, gastric neurostimulators, biliary stents, nasogastric tubes, orogastric tubes, jejunostomy tubes, gastromy tubes, and all connected components); dental implants, treatment release implants (e.g., hormone release implants, brachytherapy products, and implantable drug pumps); and medical equipment that contacts or is in proximity of the patient (e.g., stethoscopes, sphygmomanometers, otoscopes, ophthalmoscopes, bronchoscopes, endoscopes, colonoscopies, hysteroscopes,colposcopes, culdoscopes, suction tubes, specula, HVAC systems). In an embodiment, the intended form, function, and operation of the associated device are not affected by the application of, presence of, and/or changes in the composition. For example, a foley catheter equipped with a composition of the invention would still allow urine to drain from the bladder through the catheter. A pacemaker used in conjunction with the compositions of the invention would still be able to connect to operable leads that stimulate the appropriate areas of the heart.

In certain aspects, the invention can involve a piece of medical equipment with compositions of the invention, and methods of using that medical equipment with the compositions of the invention. Medical equipment is susceptible to the accumulation of unwanted material which may be transmitted directly or indirectly to patients in the care facilities. For example, the diaphragm and bell of a physician's stethoscope is generally coated in adherent microbes which are transmitted to patient skin during each use. Such equipment may include, without limitation, stethoscopes, sphygmomanometers, otoscopes, opthalmoscopes, bronchoscopes, endoscopes, colonoscopes, hysteroscopes, colposcopes, culdoscope, suction tubes, specula, and HVAC systems. Certain compositions of the invention may also be applied to other surfaces in clinical care or long term care facilities that are susceptible to biofilm formation, including without limitation, walls, tabletops, ventilation ducts, water piping, bed surfaces, door handles, and support railings. Similar to medical equipment, these surfaces are susceptible to the adhesion of unwanted material and the formation of biofilm, which can be transmitted to patients through direct or indirect means. Certain compositions may even be applied directly to human tissue, for example, to inhibit biofilm formation on teeth or wound beds which can lead to dental caries and suboptimal healing, respectively.

### Benefits of the Composition

The compositions of the invention primarily serve to prevent the accumulation of unwanted material on a surface by restricting direct contact between the surface and potential unwanted material in the environment. That unwanted material can consist of microbes, protein, other organic material, and inorganic material. Furthermore, certain compositions of the invention prevent the formation of biofilm on the actual device surface by restricting exposure of the surface to unwanted material in the outside environment. This is especially important given that the accumulation of biofilm has a significant clinical effect, in that microbes in biofilm often become multiple drug resistant to medications as compared to their free-floating counterparts. This allows the biofilm to act as a continuous source of microbes into the surrounding environment until eliminated. When microbes arrive at the surface of the compositions of the invention, the layer or layers that comprise the composition can be removed, thereby eliminating these microbes prior to, during, or even after biofilm formation. The invention recognizes that the clinical impact of biofilm stems from the continual detachment of microbes from a mature biofilm into the surrounding environment. Therefore, if the microbes in the composition are removed prior to release of a minimally infective dose of each respective adherent microbe, clinical infection can be prevented.

Certain compositions of the invention in conjunction with an underlying object surface may prevent non-infectious complications of biofilm as well, including without limitation corrosion and fracture of the underlying surface, by isolating the surface material from contact with the biofilm.

Certain compositions of the invention may prevent non-infectious but clinically relevant effects of the accumulation of unwanted material on a surface, including without limitation the accumulation of thrombotic factors and fibrin associated with vascular device thrombosis and inorganic material associated with urinary catheter encrustation.

### Timing of Removal

Compositions of the invention can comprise a single layer (i.e., a single layer composition) or multiple layers (i.e., a multilayered composition). In an embodiment, the multiple layer composition may have 2, 3, 4, 5, 6, 7, 8, 9, 10, or up to 1000 layers. The number of layers comprising the composition can vary according to the contemplated use and/or the desires of the user. For example, a single layer may be appropriate when bulk is a concern and the device and composition must occupy minimal space. A single layer may also be appropriate when cost is a concern or there is only one primary opportunity of contamination, which would be dealt with by removing the single layer after the appropriate time. Other embodiments of the invention recognize that there are uses in which microbes may adhere to the device at different times, warranting the need for several layers which can be released at different times to successively release microbes as they collect on the composition surface. For example, microbes may adhere when the device is inserted into the body. Microbes may also adhere after the device has been placed inside the body, either partially or completely. Such delayed adherence may occur due to late seeding of migratory microbes or hematogenous seeding of microbes from a distant source in the body. Accordingly, compositions of the invention may comprise multiple layers. In this embodiment, a layer can be removed shortly after insertion and subsequent layer(s) can be removed sequentially, after additional periods during which microbes may have adhered to the device. As encompassed by the invention, removal can occur through any means known in the art, including, but not limited to mechanical removal, stimulated degradation, or time-controlled degradation. As such, the durations over which any layer is removed or continues to degrade, dissolve, erode, or the like can vary as well.

Accordingly, the prevention of clinical infection due to biofilm is achievable using the multilayered compositions of the invention in the following non-limiting ways, including mechanical removal of a layer at time of insertion immediately prior to closing the surgical site; stimulated degradation of an external layer of the composition at time of insertion immediately prior to closing the surgical site; stimulated degradation at fixed time intervals; time-controlled degradation at a specified rate; or any combination of these. In an embodiment, compositions of the invention are configured such that they can be removed from an inserted medical device without having to remove the device from the patient. As discussed previously, the primary solution for dealing with a medical device with a biofilm with microbes is to remove the device from the patient and administer the appropriate antimicrobial treatment. This is undesirable as it removes the medical device and deprives the patient from receiving the benefits of the medical device.

In an embodiment, the composition of the invention begins to be removed, eroded, dissolved, degraded, or the like upon application, insertion or placement of the device on or inside the body of the patient. In an embodiment of the invention, a portion or the entirety of the composition is removed within 1, 2, 3, 4, 5, 6, 7, 8, 9, 10, 11, 12, 13, 14, 15, 16, 17, 18, 19, 20, 21, 22, 23, or 24 hours from beginning of use. In another embodiment of the invention, a portion of or the entirety of the composition of the invention is removed within 1, 2, 3, 4, 5, 6, 7, 8, 9, 10, 11, or 12 months after the beginning of use. In yet another embodiment of the invention, a portion of or the entirety of the composition of the invention is removed within 5, 10, 20, 30, 40, and 50 years after the beginning of use. The beginning of use of a composition on a surface can be defined without limitation to insertion of a medical device into a patient's body, application of composition to a piece of medical equipment or facility surface, first removal event of a portion of composition, first contact of composition with unwanted material, and first direct contact of composition with patient tissue. A portion of the composition must be defined to include the material of the composition that is directly in contact with unwanted material or has the potential to be in contact with unwanted material from the environment, which in all cases includes at least the top layer of the composition.

### Methods of Removal

Any means known in the art is useful for removing the compositions of the invention from the associated device. For example, the removal process can include the use of physical or mechanical means, chemical means, biologic mean, or energetic means to remove the composition. The removal process can further include removal by temporally-fixed degradation or stimulated degradation.

In temporally-fixed degradation, the material used to prepare the composition layer may degrade at a pre-characterized rate under given environmental conditions. In stimulated degradation, a change in the environment can be used to trigger the degradation of the composition. For example, the composition may be prepared from a polymer configured to respond to changes in the environment. Such changes can include, without limitation, changes in pH, temperature, light, electromagnetic fields, ionic factors, and interacting molecules. Certain embodiments include polymer coatings which are solid until an external stimulus, such as light at a certain wavelength, a local magnetic field, or a local electrical field are applied to elicit, for example, a change in polymer conformation or integrity leading to its dissolution. Furthermore, if the composition includes multiple layers, each layer may be configured to respond to a different stimulus. In such an embodiment, this could ensure the degradation of only one layer in response to a given stimulus at the appropriate time (when that layer is exposed to unwanted material).

In certain embodiments of the invention, the composition is configured for mechanical removal from the device. In addition, the composition may be further modified beyond the layers that comprise the composition in such a way that facilitates the physical removal of the composition. In certain embodiments, the composition may comprise tabs or tags that an operator can exert force on to remove a layer of the composition. For example, an operator may pull on the tags in order to remove a composition layer. In other aspects of the invention, the composition does not include tags or tabs, however, the operator may still physically remove the composition, for example, by pulling on an outer edge of the composition. In other aspects of the invention, the composition can be linearly perforated to facilitate separation into multiple pieces.

In an embodiment, the medical device will already be covered to some extent by the composition prior to use of the device. The composition covers at least a portion of the object surface that may be exposed to unwanted material in the environment. Additional compositions of the invention cover the entirety of an object surface, which may include without limitation inner and outer lumen surfaces in catheters, non-indwelling aspects of medical devices, and other aspects of any surface that may not directly contact the environment or patient. Certain multilayered compositions of the invention may have one layer covering one aspect of the surface and another layer covering a partially or entirely distinct aspect of the surface.

In an embodiment, the composition of the invention will be removed at a uniform rate across the entirety of the composition for any and all layers. In other embodiments of the composition, the composition may be partially or entirely removed at non-uniform rates across the composition. In yet other embodiments of the composition, the beginning time points of removal of different aspects of the composition may be distinct. For the latter two sets of embodiments, there is no link between time and space with respect to removal of the composition processes.

### Materials

In certain embodiments, the composition is comprised of biocompatible materials. In certain embodiments, the composition is comprised of one material. In certain embodiments, the composition is comprised of multiple materials. The materials may be metals, ceramics, or polymers. In certain embodiments, the composition is made of the same materials as the object surface. In other embodiments, the composition is made of different materials than the underlying surface. In certain embodiments, the polymers have stable properties and structure under processing, ambient, storage, and use conditions. Examples of such polymers include without limitation, polyurethane, polyvinyl chloride, polypropylene, polyethylene tetraphthalate (PET), polymethylmethacrylate (PMMA), polycarbonate, acronitrile butadiene styrene (ABS), polyamide (Nylon-6), polyimide, polysulfone, polyamide-imide (PAI), polytetrafluoroethylene (PTFE), polyetherimide (PEI), polyether ether ketone (PEEK), polyaryletherketone (PEAK), polyphenylene (SRP), and copolymers of the constituents of the aforementioned. In other embodiments, the polymers have changing properties or structure across processing, ambient, storage, or use conditions. In such embodiments, the composition made of aforementioned mutable polymers also undergoes property and structural changes accordingly. Such structural changes include without limitation, such property changes include physical and chemical properties including without limitation, porosity, and diffusivity.

In certain embodiments, the polymers of the composition decompose, dissolve, degrade, erode, or the like under physiologic conditions. Such degradable materials include, without limitation, polylactic acid, polyglycolic acid, polycaprolactone, polybutylsuccinate, polyhydroxyalkanoates, polyanhydrides, cellulose derivatives, polyesters, polyorthoesters, polyaminoesters, polyamides, polyanhydrides, polycarbonates, polyphosphazenes, polypropylfumarates, polyethers, polyacetyls, polycyanoacrylate, polyurethanes, polyhydroxyacids, polyacrylate, ethylene vinyl acetate, cellulose acetates, polystyrenes, polyacrylic acid, poly(vinyl chloride), poly(vinyl fluoride), poly(vinyl imidazole), poly(vinyl alcohol), poly(ethylene terephthalate), polyureas, polypropylene, polymethacrylate, polyethylene, poly(ethylene oxide), chlorosulphonated polyolefins, and copolymers of the constituents of the aforementioned.

In certain embodiments of the invention, smart polymers are used to make the composition. Smart polymers are polymers that respond to certain environmental stimuli, such as change in temperature, pH, humidity, light intensity, electrical, or magnetic field application. The properties that can change are color, opacity, conductivity, and shape. Also particularly useful property changes for biomedical applications are swelling/deswelling, micellization, solubilization, precipitation, and reversible solid-gel transitions. The most studied stimuli in biomedical applications are temperature and pH, and the most studied polymers are ones that specifically respond to changes in these stimuli around physiologic conditions (pH 7.4 and temperature of 37 degrees Celsius). Such smart polymers include without limitation poly(acrylic acid-coacrylamide), N-acryloylglycinamide (NAGA) homopolymer, and copolymers from NAGA and N-acetylacrylamide (NAcAAm), polyanhydrides, polyesters, polyorthoesters, polyacrylic acid, poly (methylacrylate), polyurethanes, poly(N-isopropylacrylamide), hydroxypropylcellulose, poly(vinylcaprolactame) and polyvinyl methyl ether, polyethylene oxide, polyvinylmethylether, and polyhydroxyethylmethacrylate.

### Methods of Making

Various means known in the art can be used to prepare the compositions of the invention. Such methods for the manufacture of compositions can vary in accordance with the desired application and selected material. In some embodiments, compositions of the invention can be formed into a composition by extrusion, injection molding, blow molding, rotational molding, thermoforming, electrospinning, casting, or any combination of these. In an embodiment, the composition and tags are formed by folding a continuous sheet of extruded material and cutting out excess material to form the desired tag configuration. Alternatively, multiple layers can be added sequentially to the underlying device manually or with custom robotic machinery. In other embodiments, shrink wrap machinery can be used to sequentially add layers to a composition.

In other embodiments of compositions, particularly for thin films, fabrication can be achieved by chemical deposition techniques such as chemical vapor deposition, atomic layer deposition, plating, spin coating, and chemical solution deposition, and physical deposition techniques such as sputtering, pulsed laser deposition, cathodic arc deposition, and electrospray deposition. In certain embodiments of a polyelectrolyte thin film composition, layer by layer processing techniques are cheap and easy to scale up. Layer by layer processing techniques include without limitation dip coating, spray coating, brush coating, roll coating, spin casting, or combinations of the aforementioned.

Additionally, any combination of the above processing methods can be utilized to fabricate one or more layers of the composition.

Any of the materials above may be modified to further decrease adhesion of unwanted material and/or to eliminate adherent microbes. Certain embodiments may incorporate into the composition antibiotics, antifungals, other antimicrobial agents, or antiseptics to kill adherent microbes. In certain aspects, the antimicrobial agent is silver-based, such as a silver alloy or silver ion.

Other embodiments may incorporate molecules or alter processing technique to affect surface characteristics known to affect adhesion of unwanted material, including without limitation hydrophilicity, hydrophobicity, wettability, and surface energy.

Other embodiments of the composition may include modifications to improve adherence of the composition to the object surface for the duration of use, which may include without limitation including a non-removable base layer in the composition and utilizing conjugation molecules to link the composition and object surface.

In certain embodiments, the mechanical properties of the composition, including its elastic modulus, tensile strength, stiffness, ductility, frictional coefficient, and shape, are as similar as possible to the underlying device at normal body temperature (37° C.). These properties are associated with the ease of device insertion and removal, kinking frequency, and damage to the surrounding tissue particularly for indwelling catheters. Additionally, they relate to risk of fracturing the composition material or damaging the underlying device during insertion or removal of any indwelling or implanted device. The thickness of the composition can vary in accordance with the application and desired mechanical properties of the material. In addition, the composition may be non-porous or porous.

Certain embodiments of the composition may include modifications in material or processing techniques to change mechanical properties, which includes without limitation chemical or energetic treatment to increase crosslinking, changing of degree of polymerization and molecular weight of constituent polymers, and changing processing techniques to modify degree of crystallinity.

Other embodiments of the composition may include material modifications for secondary purposes, including without limitation conjugation of molecules that increase endothelialization of the device for protection against biofilm formation and incorporation of polymers that confer radio-opacity to a catheter for visualization under x-ray or fluoroscopy.

Reference will now be made to the use of specific compositions and methods of removal in conjunction with specific medical devices. It is to be understood that these specific embodiments are non-limiting and further that these embodiments are readily adaptable to other medical devices, medical equipment, and surfaces in medical care facilities.

### EXAMPLE 1

An exemplary embodiment consists of a rapidly degradable polyelectrolyte thin film applied to all surfaces of the device exposed to bodily tissue during or after insertion. The surface erosion of this coating ideally begins immediately after insertion but no later than 4 hours post-insertion, prior to entry to the exponential growth phase of adherent microbes (e.g., S. aureus). As described in U.S. Pat. No. 8,106,652, hereby incorporated by reference in its entirety, polyelectrolyte thin films may be composed of two polymers, one which is positively charged and the other which is negatively charged at processing pH, that are bound together by electrostatic interactions. When one or both of the polymers is subjected to hydrolysis and separates into water soluble monomers, these electrostatic interactions between the polymers are also disrupted.

An ideal coating would be rapidly biodegradable, and the byproducts would be bioinert and water soluble at physiologic conditions. Any polyelectrolyte with hydrolytically cleavable ester, carboxyl, or amine linkages in sterically favorable conformations can be used. Polymers that are soluble in aqueous solution under physiologic conditions also can be used. Polymers with charge properties, degradation properties, and solubility properties compatible with this embodiment include without limitation polyesters, polyorthoesters, polyaminoesters, polyamides, polyanhydrides, polycarbonates, polyphosphazenes, polypropylfumarates, polyethers, polyacetyls, polycyanoacrylate, polyurethanes, polyhydroxyacids, polyacrylate, ethylene vinyl acetate, cellulose acetates, polystyrenes, polyacrylic acid, poly(vinyl chloride), poly(vinyl fluoride), poly(vinyl imidazole), poly(vinyl alcohol), poly(ethylene terephthalate), polyureas, polypropylene, polymethacrylate, polyethylene, poly(ethylene oxide), chlorosulphonated polyolefins, and combinations of the aforementioned constituents.

Certain polyelectrolyte thin film preparations have been studied for applications in drug and gene delivery and have demonstrated favorable degradation profiles useful in the compositions of the invention. For example, polymer 1, a poly-beta-amino-ester, described in U.S. Pat. No. 7,427,394, hereby incorporate by reference in its entirety, and utilized in the decomposable thin films described in Wood et al. with the polyanions heparin and chondroitin sulfate, 2005 demonstrates a degradation half-life of under two (2) hours at a physiologic pH of 7.4 with surface erosion beginning immediately after exposure to an aqueous environment. Similar degradation profiles can be achieved with a bioinert polyanion in place of heparin or chondroitin sulfate, such as polyacrylic acid, given the erosion rate is highly dependent upon the degradation rate of polymer 1. Many methods to increase surface erosion rate of a polyelectrolyte thin film may be used, including pre-treatment with a more basic solution (pH>7.4) to expose the hydrolytically susceptible linkages to additional free hydroxyl groups, increasing hydrophilicity of the coating top layer, decreasing polymer crystallinity, and decreasing polymer molecular weight.

For the described polyelectrolyte thin film embodiment, layer by layer processing techniques are cheap and easy to scale up. Layer by layer processing techniques include without limitation dip coating, spray coating, brush coating, roll coating, spin casting, or combinations of the aforementioned.

Such a polyelectrolyte thin film embodiment of the invention can be applied to any surface but is especially useful for the prevention of biofilm formation and subsequent clinical infection on any implanted or indwelling device in addition to prevention of vascular device thrombosis, and urinary catheter encrustation.

### EXAMPLE 2

In another embodiment, the composition can be a non-degradable composition that is removed mechanically using a ‘peel-away’ method during or following insertion. The peel-away or inside-out removal method is intended to encapsulate the biofilm during composition removal as to prevent dispersal of microbes into host tissue. Such embodiments can be single-layered or multilayered.

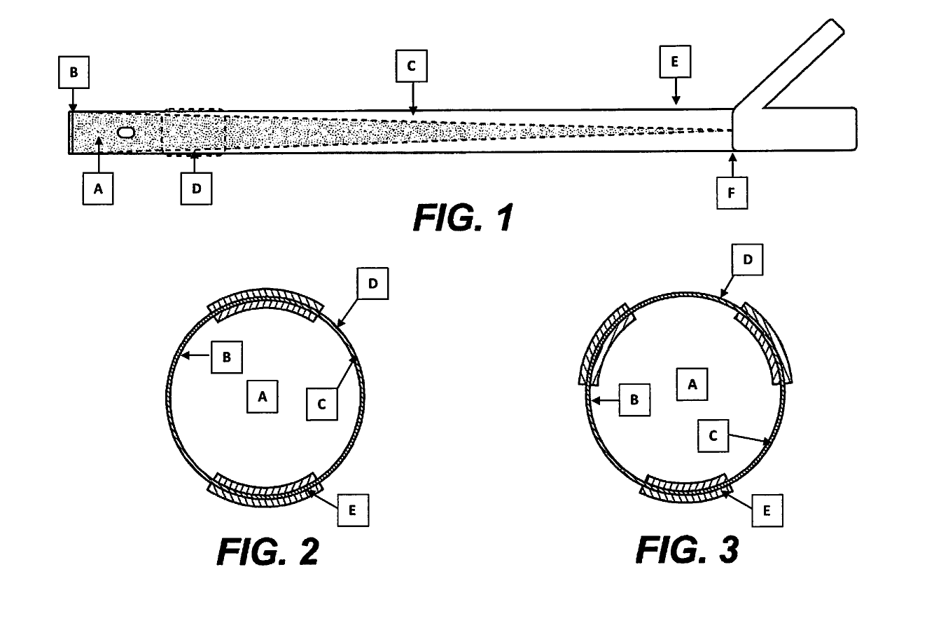

The following embodiment describes a non-degradable multilayered composition that can be mechanically removed utilizing a ‘peel away’ method as it is applied onto the extraluminal surfaces of short-term use (i.e. less than 14 days) foley catheters to prevent catheter-associated urinary tract infection secondary to biofilm formation on the foley catheter surface. Such an embodiment is depicted from a side view in FIG. 1.

In FIG. 1, element 1.A refers to a tag or tab which is non-adherent to the underlying layer of composition except at the distal end, such that a force applied at the proximal end will translate to the distal end of the tag and evert the underlying layer at the connection point. 1.B refers to the connection point between the tag/tab and the underlying composition layer, which occurs at the distal end of the foley catheter, wherein the distal end is the end that is inserted into the bladder. If there are a plurality of layers other embodiments of the composition, and there may be tags/tabs connected to any or all layers of the composition in similar or different configurations. 1.C refers to a layer of the composition which is lying between the tag and the foley surface. 1.D refers to the eyelet hole through which urine is drained from the bladder into the internal lumen of the distal end of the foley catheter. The eyelet hole penetrates all layers of the composition including all tags/tabs. 1.D refers to the location of the foley balloon, which is underlying the composition and a considered part of the base foley catheter surface. This balloon is inflated to hold the foley catheter in place following advancement of the distal end into the bladder. 1.E refers to the proximal end of the foley catheter, which lies external to the periurethral area when the device is inserted into the body. 1.F refers to the foley catheter inlet and outlet bifurcation. The inlet is used to feed fluid for inflation of the balloon. The outlet is used to drain urine from the foley catheter, often into pre-connected tubing and urine collection bag.

FIG. 2 also shows the foley catheter with a composition of the invention. In FIG. 2, the tag configuration consists of two tags at 180 degrees of separation around a catheter with a cyclindrical cross-section. 2.A refers to the internal lumen of the catheter. 2.B refers to the body of the catheter. 2.C refers to the surface of the catheter. 2.D refers to the surface of the composition layer. 2.E refers to the connection point between the tag and the underlying layer of the composition at the distal end of the catheter.

FIG. 3 shows another embodiment of a foley catheter with a composition of the invention. In FIG. 3, the tag configuration consists of three tags at 120 degrees of separation around a catheter with a cyclindrical cross-section. 3.A refers to the internal lumen of the catheter. 3.B refers to the body of the catheter. 3.C refers to the surface of the catheter. 3.D refers to the surface of the composition layer. 3.E refers to the connection point between the tag and the underlying layer of the composition at the distal end of the catheter.

In the described embodiment, the composition is applied only to the external surface of the catheter, which is appropriate when the foley has been preconnected to a urine collection bag, as sterile closed systems help minimize microbe migration and biofilm formation on the intraluminal surface of the catheter. In certain aspects, the composition completely encapsulates the catheter from the distal end to the split junction of the catheter at the proximal end. The outermost layer would be removed as the catheter is advanced through the urethral tract or immediately following insertion to eliminate microbe seeding during insertion. Microbe migration and biofilm formation along the extralumenal surface of the catheter has been estimated to take 3-7 days. Taking this into consideration, an additional layer from the composition can be removed approximately every 3 days after insertion, which would preclude microbial detachment from a mature biofilm inside of the host and subsequent clinical infection for a minimum of 15 days post-insertion for a 5-layer composition.

Once the device is inserted, the composition covering the catheter can be removed. The following is a description of a peel-away “inside-out” method of removal that encloses the biofilm within the removed layer, thereby minimizing the risk of microbe dispersal during the removal process. In described aspects, this method makes use of tags for each layer that connect to the distal end of the composition and are non-adherent at the proximal end of the device. The tags can take any shape and connect along any part of the circumference of the distal end of the composition. Compositions with two and three tags are presented from a frontal perspective in FIGS. 2 and 3, respectively.

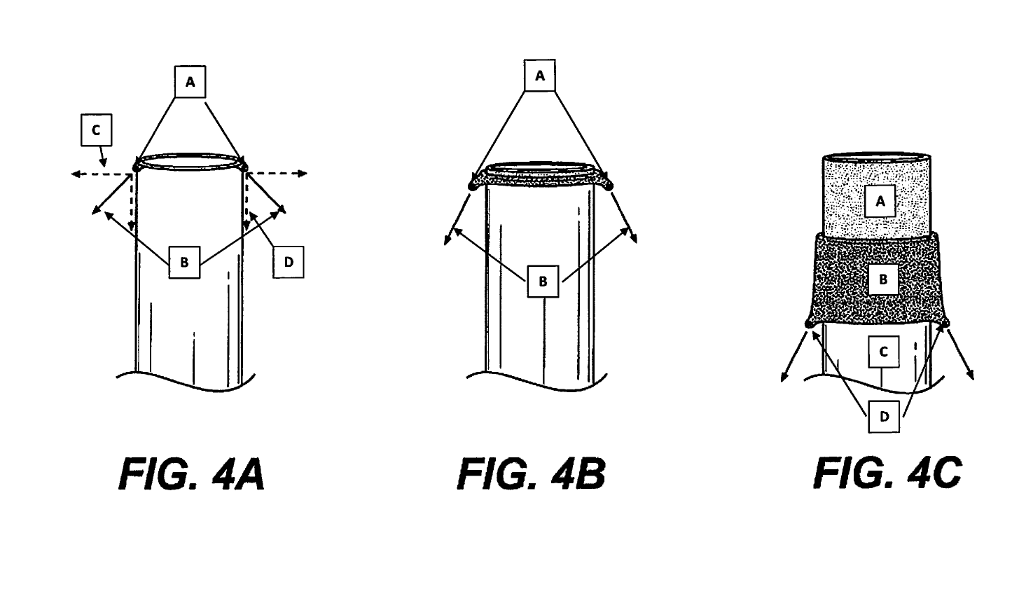

FIG. 4 shows one embodiment for removing the compositions of the invention from a catheter. It depicts the progressive steps of a mechanical peel-away method as described above using tags. In FIG. 4A a catheter is shown with an overlying composition layer prior to removal. 4A.A refers to the connection points of the tags with the underlying composition layer at the distal end of the catheter. Tags are not depicted for clarity of the drawing. 4A.B refers to the net force vector applied to the connection point when retraction pressure is applied to the proximal end of the tag, as described in Example 2. 4A.C refers to the x force vector components of the net force vectors depicted in 4A.B at either connection point. The x force vector components are primarily responsible for eversion of the underlying layer the connection point. 4A.D refers to the y force vector components of the net force vectors at either connection point depicted in 4A.B. The y vector components are primarily responsible for the retraction of the layer of the composition from distal to proximal end. The net result of the x and y components of the force vector is an eversion and retraction, also known as an inside-out peel-away.

An exemplary procedure for removing a multilayered composition from a foley catheter is now provided.

The retraction pressure that is applied to the proximal end of the tags is translated to the distal end of the tag, which is connected to the distal end of the composition. This tension pulls the composition towards the urethral opening from the distal to proximal end, causing an inversion of the composition at the distal end similar to inverting a glove during sterile removal or peeling a banana. The process of peeling away the outermost layer is depicted in FIGS. 4A-4C.

In certain embodiments of the invention, the outermost layer of the multilayer composition is removed during advancement of the catheter. In other embodiments, the outermost layer is removed following insertion. If the layer is removed during insertion, once the distal end of the foley catheter is inserted a desired distance beyond the urethral opening, for example 5 cm, the operator grasps the proximal tags with his nondominant hand and continues to advance the foley with his dominant hand. The distal edge of the composition should remain a certain distance, for example, 2 cm, distal to the urethral opening until the distal tip of the foley is advanced into the bladder, i.e., until urine is visualized in the catheter. The operator will then inflate the balloon to secure the position of the foley within the bladder. The operator can then apply light retraction pressure on the tags and light advancement pressure on the foley, in a traction-countertraction method, to fully remove the composition outside of the urethral opening and avoid pulling the balloon against the bladder opening. Subsequent layers can be removed following insertion with similar traction-countertraction pressure application to the composition tags and foley, respectively.

In addition to the aforementioned foley catheter, this method is applicable to any and all indwelling or implanted medical devices from which compositions can be removed sequentially through a small orifice, including without limitation venous catheters, nephrostomy tubes, chest tubes, neurovascular shunts, and an implanted device prior to closing of the insertion site.

### EXAMPLE 3

In another embodiment, the composition can be a non-degradable composition that is removed mechanically without using a ‘peel-away’ method during or following insertion. Such a method would be more utilized for implanted devices at insertion, wherein the peel-away method may be more difficult to execute due to geometries of the devices and their insertion sites. The following embodiment describes a non-degradable multilayered composition that can be mechanically removed at insertion to prevent biofilm formation and subsequent clinical infection secondary to microbe seeding during or prior to insertion to prevent catheter-associated urinary tract infection secondary to biofilm formation on the foley catheter surface.

Transvenous pacemakers and intracardiac defibrillators, also referred to as cardiovascular implanted electronic devices (CIEDs), generally consist of two components, a pulse generator that is implanted subcutaneously in the abdominal or pectoral area and one to three leads inserted through the central venous system and implanted distally into heart tissue in one or more chambers. As with other implantable medical devices, microbes are most often seeded onto the device during implantation, from contact with the skin or contaminated operator hands, and can enter into exponential growth phase within 4 hours following insertion. This embodiment describes a composition that is removed following implantation of the CIED but prior to closing of the insertion site, which should generally be less than 4 hours following any seeding event during insertion.

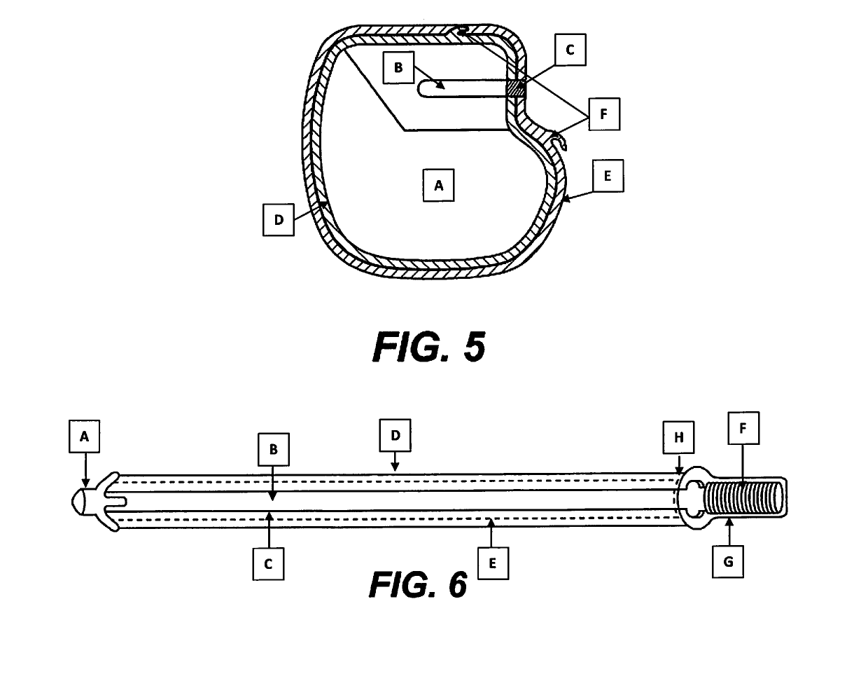

Compositions used in conjunction with CIEDs may comprise single or multiple layer compositions. An exemplary embodiment is depicted in FIG. 5. FIG. 5.A refers to the generator body. 5.B refers to the socket through which the leads are connected to the generator. There may be multiple sockets for CIEDs designed for use with multiple leads. 5.C refers to the opening through the overlying layers of the composition leading to the lead socket, such that the lead can be connected while the composition is overlying the generator surface. 5.C refers to the generator surface. 5.D refers to one layer of the composition. 5.E refers to a second layer of the composition. Method of use for this embodiment would entail removal of 5.E immediately following insertion of the device before closure of the surgical insertion site. 5.D would remain on the device surface for removal at a later date if contamination of the surface with biofilm was suspected. 5.F refers to ‘outpouchings’ created such that the operator can cut or nick the outpouching for removal of one layer with minimal risk of puncturing or damaging the underlying layer.

The composition preferably fits closely to the generator surface to reduce bulk and minimize material use. The composition can be prepared from any material known in the art, however, in certain embodiments, the composition is prepared from a thinly extruded biocompatible polymer, such as polypropylene or polyethylene. In this embodiment, the outermost layer would be removed by the operator in a sterile field just before closing the surgical entry site by cutting the layer and pulling it off the generator and lead(s). The ‘outpouchings’ depicted in FIG. 5 are ideal points for cutting in order to ensure the integrity of the underlying layer is not compromised. Any additional layers can be removed in a similar manner from the generator if it is suspected to be coated in biofilm. If the tissue in the generator pocket is suspected to be infected, the pocket site of the device can further be debrided and disinfected. In this instance, the generator can be moved to another implantation site after the layer is removed in order to prevent re-seeding of the infected pocket. After completing this step, an additional layer may be removed soon thereafter prior to closing the new implantation site. In this exemplary embodiment and procedure, the generator is not disconnected from the leads.

In certain embodiments, the leads of the CIED are also protected by compositions in accordance with the invention. An exemplary embodiment is provided in FIG. 6. The bilayers depicted in FIG. 6 can be mechanically removed without a peel away technique by just retracting the layer material at the proximal end. 6.A refers to the lead electrode, which is inserted distally into cardiac tissue. The surface of the electrode is not covered by the composition. 6.B refers to the lead body, which transmits the pulse from the generator to the electrode. 6.C refers to the surface of the lead body. 6.D refers to the outer layer of the composition which lies between the external environment and another layer of the composition. 6.E refers to the inner layer of the composition which lies between the outer layer of the composition and the lead surface. 6.F refers to the proximal end of the lead that connects to the generator. 6.H is the point at which the lead body is attached to the portion of the lead that connects to the generator. 6.G refers to another portion of the top layer which is detachable at 6.H so the layer can be removed fully over the lead prior to connection to the generator. 6.G and 6.D are removed after implantation of the lead electrode prior to the connection of the lead with the generator at the proximal end. 6.E will be left in place after insertion for removal if biofilm formation is suspected at a later date.

In this embodiment, the initial layer is removed following implantation of the lead electrodes into heart tissue and immediately prior to connecting the leads to the generator for testing to minimize risk of seeding of the underlying surface prior to surgical site closure. When CIED-associated infection is suspected following implantation, an additional layer can be removed percutaneously or through open surgery. In certain percutaneous method embodiments, the adhesions between the vessels and the lead can be removed with a mechanical dilator composition or laser sheathing tool as is done for lead extraction currently prior to peeling away another layer. The composition layers are stiff and can be removed manually without a stylet or with the aid of a stylet that advances through the lumen between the lead and composition layer. In this embodiment, the need for countertraction during the elimination process would be eliminated, as there would be minimal opposing friction forces between the lead and composition layer. If the composition is prepared from a stiffer material, the distal end may be blunt and rounded as to avoid irritation of the contacting heart tissue.

Such a composition with the above described mechanical removal process can be applied to any indwelling or implanted medical device, medical equipment, or medical care facility surface to mitigate accumulation of unwanted material on its surfaces in addition to mitigating transfer of that unwanted material to patient tissue. For example, placing a replaceable multilayered mechanically composition over the diaphragm and bell of a practitioner's stethoscope can mitigate transfer of microbes between patients if the practitioner removes one layer between uses.

### EXAMPLE 4

In this embodiment, smart polymers are used in the compositions of the invention to make a removable composition that is stable under ambient and storage conditions but changes properties at physiologic conditions. One such embodiment includes a composition of a polymer that is immiscible with water at room temperature and miscible with water at physiologic temperature. Such a polymer would have an upper critical solution temperature greater than room temperature (20 degrees Celsius) and below physiologic temperature (37 degrees Celsius), and it would be solid in aqueous solution at room temperature and miscible in aqueous solution at physiologic temperature. Such a polymer applied to devices can act as a coating that degrades only after insertion. Smart polymers useful in such compositions include without limitation poly(acrylic acid-coacrylamide), N-acryloylglycinamide (NAGA) homopolymer, and copolymers from NAGA and N-acetylacrylamide (NAcAAm).

Such an embodiment would be ideally applied to indwelling and implanted medical devices to prevent biofilm formation and subsequent clinical infection. It can also be used in conjunction with vascular devices to prevent thrombosis and urinary catheters to prevent encrustation.

### EXAMPLE 5

Another embodiment of a composition comprised of smart polymers utilizes local changes in pH for biofilm to induce solubilization of a polymer coating locally. Certain bacterial species, such as Proteus and Providencia spp, have demonstrated marked local changes in pH through the release of urease. The pH of urine in the presence of these species in biofilm is approximately 8.3. This has been well studied because of the downstream effects of crystallization of local organic and inorganic material and encrustation of urinary catheters. The pH of normal urine is 6.0, and a smart polymer that dissolves around pH 7.5-8.3 can release adherent microbes from the device surface. Similarly, local pH gradients have been demonstrated in Psuedomonas biofilms in vitro, with a gradient of pH 5.6 in the biofilm compared to pH 7.0 in the bulk fluid. An initial ideal application for such an embodiment would be on urinary catheters, particularly long-term foley catheters, and nephrostomy tubes for the prevention of encrustation.

### EXAMPLE 6

In a different embodiment of a smart polymer, the composition of the invention swells under physiologic conditions, such that its pores increase in diameter. Such a composition can be used as the top coat of a multilayered coating, such that the pores increase in size upon insertion of the device into the body, and water can then penetrate an underlying layer of the coating. This underlying layer can be a polymer that is very susceptible to hydrolytic or enzymatic cleavage under physiologic conditions with soluble monomer subunits, or may be soluble in aqueous solution as a polymer under physiologic conditions. The result of inserting a device with such a dual layered coating into the body would be an immediate swelling of the top layer with an increase in pore size, penetration of water to the underlying layer, solubilization of the underlying layer and detachment of the top coat from the underlying device. This embodiment would be best utilized in cases where the top layer is needed to maintain stability of the polymer in the underlying layer in ambient or storage conditions. As with the other degradable, dissolvable, erodible embodiments of the composition, this embodiment is best applied to the surfaces of indwelling and implanted device to mitigate clinical and non-clinical detrimental effects of the accumulation of unwanted biological material.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

I claim:

1. A method for removing an unwanted material from a surface, comprising the steps of:
placing a composition on the surface, wherein the composition is comprised of one or more materials;
putting the surface and the composition into an environment, whereby the composition may be exposed to the unwanted material;
removing at least a portion of the composition from the surface whereby some or all of the unwanted material which has deposited is removed in conjunction with the composition.

2. The method of claim 1, wherein the composition protects the surface from exposure to the unwanted material when the surface is placed into the environment.

3. The method of claim 1, wherein the removing of a portion or an entirety of the composition occurs over a given duration of time.

4. The method of claim 3, wherein the removing begins within a given time period following exposure of the composition to the unwanted material.

5. The method of claim 4, wherein the surface is on a medical device, and wherein exposure of the composition to the unwanted material occurs prior to or during insertion of the medical device into a patient body.

6. The method of claim 4, wherein that given time period is no greater than an operation lifetime of the medical device.

7. The method of claim 3, wherein the given duration of time is less than 4 hours.

8. The method of claim 3, wherein the given duration of time is no greater than an operation lifetime of the medical device.

9. The method of claim 3, wherein the removing does not occur at a fixed rate.

10. The method of claim 1, wherein the composition is partially or completely removed by a mechanical means.

11. The method of claim 1, wherein the composition is partially or completely removed by a process selected from the group consisting of a degradation, a dissolution, a decomposition, an erosion, and a conformational change.

12. The method of claim 11, wherein the removing is induced by a change in at least one environmental variable selected from the group consisting of a chemical variable and an energetic variable.

13. The method of claim 12, wherein the environmental variable is selected from a group consisting of a temperature, a pH, an ion, an electrical field, a magnetic field, a light wavelength, a light intensity, a nuclear radiation, a solar radiation, a presence of an aqueous solution, a presence of a free hydroxyl group, a presence of a cleaving enzyme, an absence of an aqueous solution, an absence of a free hydroxyl group, and an absence of a cleaving enzyme.

14. The method of claim 1, wherein the unwanted material is selected from a group consisting of a fungi, a bacteria, a virus, a protein, a carbohydrate, a lipid, an inorganic molecule, and a combination of any of the members of the group.

15. The method of claim 1, wherein the composition is comprised of a component selected from a group consisting of a metal, a ceramic, a polymer, a natural fiber, a synthetic fiber, a carbon fiber, and a combination of any members of the group.

16. The method of claim 1, wherein the surface is defined as a boundary of an object that the composition protects from the environment.

17. The method of claim 16, wherein the object has an intrinsic form and an intrinsic functionality.

18. The method of claim 17, wherein the composition does not alter the intrinsic form and the intrinsic functionality of the object.

19. The method of claim 17, wherein the object is selected from the group consisting of an indwelling medical device, an implanted medical device, and a piece of medical equipment.

20. An article comprising a medical device configured for at least partial insertion into a body; and a composition covering a surface of the medical device, wherein at least a portion of the composition can be removed at a desired time and over a desired duration of time from the surface of the medical device.
